(19) United States
(12) Patent Application Publication
(10) Pub. No.: US 2013/0252570 A1
(43) Pub. Date: Sep. 26, 2013

(54) URGENT CALL MANAGEMENT SYSTEM

(71) Applicants: Dimitre Davidov Kostadinov, Nozay (FR); Yann Toms, Nozay (FR); Guy-Bertrand Kamga, Nozay (FR); Jerome Picault, Nozay (FR)

(72) Inventors: Dimitre Davidov Kostadinov, Nozay (FR); Yann Toms, Nozay (FR); Guy-Bertrand Kamga, Nozay (FR); Jerome Picault, Nozay (FR)

(73) Assignee: ALCATEL LUCENT, Paris (FR)

(21) Appl. No.: 13/818,354

(22) PCT Filed: Aug. 22, 2011
(86) PCT No.: PCT/EP11/64403

§ 371 Date: May 3, 2013

(30) Foreign Application Priority Data
Aug. 25, 2010 (FR) 1056753

(51) Int. Cl. H04W 4/22

(52) U.S. Cl. CPC H04W 4/22
USPC 455/404.1

(57) ABSTRACT

In order to contact a user who owns a mobile terminal (TM), who is the recipient of a call from a calling user's communicating device (DCa) to the mobile terminal and who cannot be reached by means of the mobile terminal over a telecommunications network (RT), a communication server (SC) determines a level of urgency of the call, determines a list of third-party users who may be placed in contact with the calling user, based on the social relationship between the called user and each third-party user, on geolocation data (Dg) related to the called user and related to third-party users, and on the call's level of urgency, and establishes a call between the calling user at least one third-party user on the list.

The present invention pertains to an urgent call management system, and more particularly a system for contacting a user who is the recipient of an urgent call and who cannot be reached via his or her mobile terminal.

Currently, a user with a mobile terminal might still be unreachable, because his or her accessibility depends on the environment in which the user is located. This is because it is common for the user to be unable to hear his or her mobile terminal ring, when for example, the user does not have his or her mobile terminal with him or her, or because the ring volume is not high enough, or the network's coverage is too weak, or the mobile terminal is off.

Thus, a user may miss a call for multiple reasons, without knowing how important it was. In an emergency, it is not possible to alert the user even though he or she owns a mobile terminal.

There is therefore a need to reach a user by other means.

One goal of the invention is to remedy the aforementioned shortcomings by proposing a communication system enabling a user to be alerted of an emergency when the user cannot be called via his or her mobile terminal.

To achieve this goal, a method is disclosed for contacting a user who owns a mobile terminal, who is the recipient of a call from a calling user's communicating device to the mobile terminal, and who cannot be reached via the mobile terminal over a telecommunications network, said method comprising the following steps within a communication server:

determining the call's level of urgency,

determining a list of third-party users who might contact the calling user, based on the social relationship between the called user and each third-party user, geolocation data related to the called user and related to the third-party users, and the call's level of urgency, and

establishing a call between the calling user and at least one third-party user on the list.

Advantageously, whenever the call made by the calling user is urgent, the calling user may be put in contact with a third-party user who will then be able to inform the called user of the message corresponding to the urgent call. The called user may thereby be contacted by a third-party user to be notified of an urgent call, even when the called user cannot be reached via his or her mobile terminal.

According to another characteristic of the invention, the list may contain an ordered enumeration of the third-party users geographically closest to the called user.

According to another characteristic of the invention, the geolocation data may comprise the last known geographic position of the called user and of each of the third-party users.

According to another characteristic of the invention, the geolocation data related to the called user may comprise presence data related to the called user's calendar.

According to another characteristic of the invention, the communication server may have previously saved a group of third-party users who have agreed to potentially be called in order to contact the called user, based on the social relationship between the third-party user and the called user.

According to another characteristic of the invention, the communication server may determine said list of third-party users by first producing an initial list from users belonging to said group based on the call's level of urgency and then by producing said list based on the geolocation data related to the called user and related to the third-party users found on said initial list.

According to another characteristic of the invention, the call's level of urgency may be determined by transferring the call to a voice server that has a system for assessing the call's level of urgency. For example, the level of urgency is given by the user and then approved either automatically by an analysis system or manually via a dedicated call center.

The invention also relates to a communication server for contacting a user who possesses a mobile terminal, who is the recipient of a call from a called user's communicating device to the mobile terminal, and who cannot be reached via the mobile terminal over a telecommunications network, said communication server comprising:

means for determining a level of urgency of the call,

means for determining a list of third-party users who might contact the calling user, based on the social relationship between the called user and each third-party user, geolocation data related to the called user and related to the third-party users, and the call's level of urgency, and

means for establishing a call between the called user and at least one third-party user on the list.

The invention also pertains to a computer program capable of being implemented within a server, said program comprising instructions which, whenever the program is executed within said server, carry out the steps according to the inventive method.

The present invention and the benefits thereof shall be better understood upon examining the description below, which makes reference to the attached figures, in which:

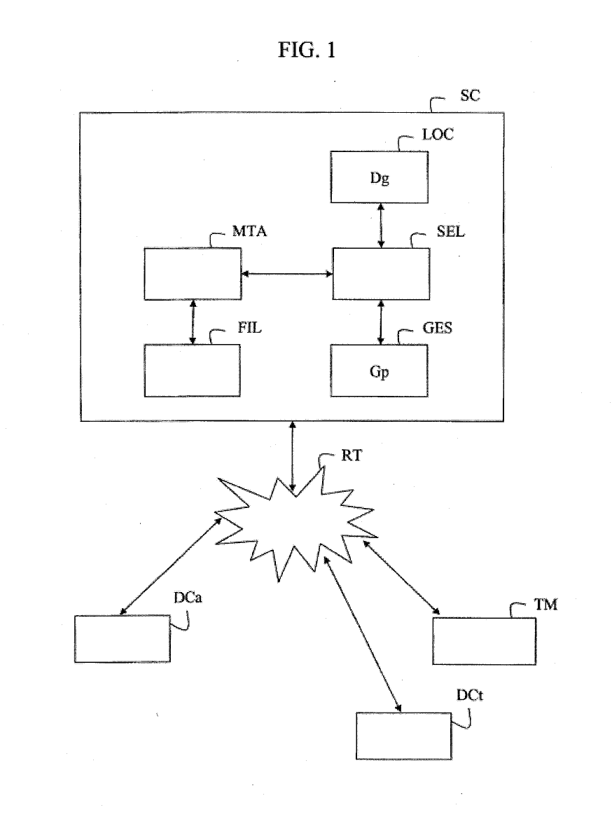

FIG. 1 is a schematic block diagram of a communication system for contacting a called user who cannot be reached via his or her mobile terminal according to one embodiment of the invention, and

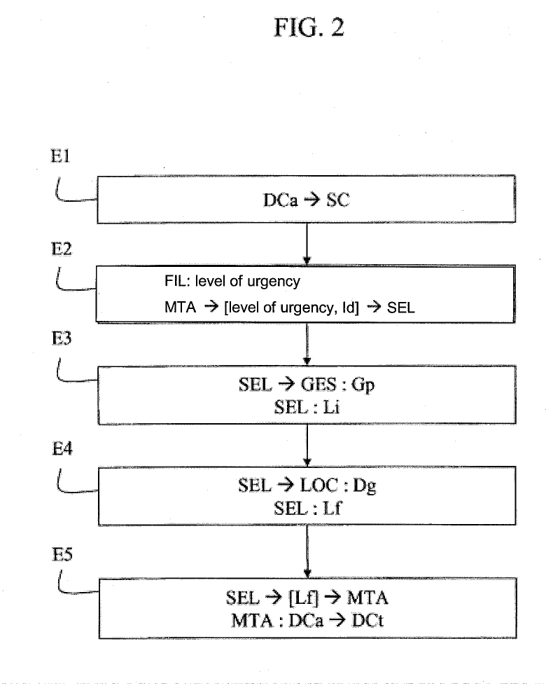

FIG. 2 is an algorithm of a method for contacting a called user who cannot be reached via his or her mobile terminal according to one embodiment of the invention.

The invention pertains to the communication system in which a “calling” user calls a “called” user who has a mobile terminal, the called user being unreachable via his or her mobile terminal. The communication system allows the calling user to be put in contact with a “third-party” user who is capable of contacting the called user.

It is assumed that the called user and third-party users have subscribed to a service according to the invention. For example, each user that has subscribed to the service may be declared as a called user and third-party user.

With reference to FIG. 1, a communication system comprises a calling user's communicating device DCa, a called user's mobile terminal TM, at least one communicating device DCt of a third-party user, and a communication system SC, capable of communicating with one another over a telecommunications network RT.

The telecommunications network RT may comprise a wireless network, such as a GSM (“Global System for Mobile communications”) or UMTS (“Universal Mobile Telecommunications System”) digital cellular radio communication network. The telecommunications network RT may be connected to an IMS (“IP Multimedia Subsystem”) packet network. Furthermore, the telecommunications network RT may comprise a wired network or be a combination of wired and wireless networks.

According to one example, a communicating device DCa of a calling user, a mobile terminal TM of a called user, or a communicating device DCt of a third-party user is a mobile cellular radio communication terminal, connected by a radio communication channel to an access network comprising the fixed-line network of a radio communications network, for example a GSM or UMTS network.

According to another example, a communicating device DCa of a called user, a mobile terminal TM of a called user, or a communicating device DCt of a third-party user comprises a telecommunications device or electronic object that is personal to the user and which may be a communicating personal digital assistant PDA, or a smartphone, which may be connected to an access terminal of a short-range public wireless network of the WLAN (“Wireless Local Area Network”) type or one compliant with the 802.1x standards, or a medium-range one according to the WiMAX (“Worldwide Interoperability Microwave Access”) protocol.

According to another example, a communicating device DCa of a calling user or a communicating device DCt of a third-party user is a TDM (“Time Division Multiplexing”) fixed-line telephone, or a fixed-line voice over IP (“Internet Protocol”) telephone, or a POE (“Power Over Ethernet”) fixed-line telephone.

Optionally, the communicating device DCa of a called user, a mobile terminal TM of a called user, or a communicating device DCt of a third-party user are capable of communicating via a short-range wireless connection of the Wi-Fi or Bluetooth type.

Furthermore, a third-party user may possess multiple communicating devices DCt, for example a mobile terminal and a fixed-line telephone.

The communication server SC may comprise a set of servers that each provide one or more features of the communication server SC. The communication server SC is, for example, managed by a telecommunications operator.

The communication server SC comprises a call processing module MTA, a filter module FIL, a selection module SEL, a preference management module GES, and a location module LOC.

In the remainder of the description, the term module may designate a device, a software program, or a combination of computer hardware and software, configured to execute at least one particular task.

The call processing module MTA processes a call coming from the caller's communicating device DCa whenever the call did not go through. For example, the call processing module MTA is triggered after the called user's mobile terminal TM has rung a given number of times, or whenever the mobile terminal does not have network coverage or is switched off.

The call processing module MTA has the functionality of transferring a call to a communication device DCt of a third-party user close to the called user, according to the principle described below, by working with the filter module FIL and the selection module SEL.

The filter module FIL has the functionality of verifying a call's level of urgency, and ensuring that the service offered by the communication server is not being misused.

For example, the filter module FIL transfers the call to the call center so that the person can talk with the calling user and determine the call's level of urgency.

According to another example, the filter module FIL offers a voice server functionality inviting the calling user to select or specify the call's level of urgency.

In one variant, the filter module FIL may conduct an automatic analysis of the caller's voice and ask a series of questions in order to deduce the call's level of urgency, for example by using a decision tree.

Optionally, in order to limit the use of the service delivered by the call server, the call may be charged based on the degree of urgency, or a user who is close to the called user and to whom the call is routed may provide an opinion about the call's degree of urgency.

The call's level of urgency may be determined based on a predefined urgency scale, and optionally may be divided into two categories: a first category exclusively for extremely urgent calls, those which are “life and death”, and a second category for other urgent calls, those which are “very urgent” or “personal”, etc.

According to one embodiment, the: user may be invited by a voice server to select the call's level of urgency. Next, that level is assessed by the system through a series of questions, and optionally a voice analysis, before the selection module SEL determines a list of third-party users who may be placed in contact with the calling user depending on the call's level of urgency. The list of third-party users for a “just urgent” call may be more restrictive than a list of third-party users for an “extremely urgent” call, with the latter potentially including people who do not know the called user.

The selection module SEL selects a third-party user may be placed in contact with the calling user in order for the third-party user to be able to contact the called user.

The selection module SEL works with the filter module FIL and the call processing module MTA to adopt the call's level of urgency as input data, queries the location module LOC to learn the positions of users who may potentially be placed in contact with the calling user, and queries the preference management module GES to learn the social relationship between the called user and third-party users who may potentially be placed in contact with the calling user as well as the preferences of the user and third-party users.

The selection module SEL produces a list of people who are geographically close to the called user and his preferences match the call's level of urgency.

For example, priority may be given to people who know the called user, who are geographically close to the called user, and who agree in their preferences to be placed in contact with a calling user with a low level of call urgency.

The location module LOC monitors the geographic positions of the called user and third-party users. The location module LOC determines the geographic position of users with a given precision.

For example, a user's location may be determined via GPS (“Global Positioning System”) data retrieved from the called user's mobile terminal or the communicating device DCt of the third-party user, including a GPS positioning system.

According to another example, a user's location may additionally be determined by means of presence data related to the user's calendar. For example, the called user may have filled out a calendar indicating that he or she is at the dentist during a given time.

The location module LOC thereby saves geolocation data Dg related to the called user and related to third-party users who may potentially be placed in contact with the calling user. The geolocation data Dg may comprise the last known geographic position of the called user and of each of the third-party users who may potentially be placed in contact with the calling user, as well as their habitual movements.

The preference management module GES enables users to specify their preferences with respect to how they may be contacted and by whom.

With respect to the called user, the user informs the third-party users whom he or she may be contacted by whenever he or she cannot be reached via his or her mobile terminal, depending on the call's level of urgency.

The third-party users maybe classified into categories such as “family”, “friends”, “others” via a social network. In that case, the called user may, for each category of social relationship, assign a minimum level of urgency for a call in order for the call to be routed to a third-party user classified within the category. For example, a user classified in the “family” category may be selected for routing the call regardless of the call's level of urgency, while a third-party user classified in the “others” category may be selected for routing the call only for the call's highest level of urgency.

With respect to a third-party user, that user informs the potential called users for whom the third-party user agrees to be called in order to contact the called user, depending on the call's level of urgency.

Furthermore, the policies for bringing a third-party user in contact with the calling user depend on the social relationship between the third-party user and the called user. For example, a third-party user may agree to be placed in contact with a calling user only if the called user is a friend or family member. Furthermore, any third-party user may agree to be placed in contact with a calling user if the call's level of urgency is high.

The preference management module GES saves users' preferences, as a potential called user and a potential third-party user, and compares the called user's preferences and third-party users' preferences in order to define a group Gp of third-party users who may be placed in contact with a calling user based on the call's level of urgency.

For example, a user's preferences may be entered by the user via a web interface.

With reference to FIG. 2, a method for contacting a call user who cannot be reached by means of his or her mobile terminal according to one embodiment of the invention comprises steps E1 to E5.

Beforehand, the called user connects to a web interface to inform the third-party users whom he or she may be contacted by whenever he or she cannot be reached via his or her mobile terminal, based on the social relationship between the called user and each third-party user and based on the call's level of urgency.

Furthermore, at least some of said third-party users connect to a web interface in order to inform potential called users for whom each third-party user has agreed to be called in order to contact the called user, based on the social relationship between the third-party user and each called user and based on the call's level of urgency.

The communication server SC retrieves said information provided to the web interface in order to define and associate a group Gp of third-party users to the called user, the group's third-party users potentially being placed in contact with a calling user based on the social relationship between the third-party user and each called user and based on the call's level of urgency. For example, the group of third-party users is saved as a match with an identifier of the called user, and each third-party user is saved as a match with a call number of at least one communicating device DCt.

In step E1, a calling user calls the called user but cannot reach him or her. For example, after the called user's mobile terminal TM has rung a given number of times, the communication server SC is triggered by a home location register HLR which is included in the telecommunication network RT and which comprises the called user's profile information, particularly the services which that user has subscribed to, and the calling user's communicating device DCa is placed in contact with the communication server SC.

In step E2, the filter module FIL determines the call's level of urgency. For example, the filter module FIL transfers the call to a voice server that has a system for assessing the call's level of urgency, inviting the calling user to select the call's level of urgency, which is evaluated by the system through a set of questions, and optionally a voice analysis. The call's level of urgency may be transmitted to the communication server, for example in the form of a text message.

The call processing module MTA retrieves the call's level of urgency determined by the filter module FIL and transmits it to the selection module SEL.

The call processing module MTA also transmits an identifier Id of the called user to the selection module SEL. The identifier Id is, for example, the call number of the called user.

In step E3, the selection module SEL queries the management module GES in order to retrieve the group Gp of third-party users associated with the called user, by means of the identifier Id of the called user.

The selection module SEL produces an initial list Li of third-party users belonging to the group Gp based on the call's level of urgency. The policies for bringing a third-party user in contact with the calling user depend on the social relationship between the third-party user and the called user. For example, a third-party user may agree to be placed in contact with a calling user, only if the called user is a friend or family member. Furthermore, any third-party user may agree to be placed in contact with a calling user if the call's level of urgency is high.

Thus, only third-party users who had agreed to be placed in contact with a calling user for the determined level of urgency belong to the initial list Li.

In step E4, the selection module SEL queries the location module LOC to learn the positions of the third-party users on the initial list Li. In particular, the selection module SEL retrieves geolocation data Dg related to the called user and related to the third-party users, comprising for example the last known geographic position of the called user and of each of the third-party users.

The selection module SEL produces a final list Lf of third-party users from the initial list Li based on the retrieved geolocation data Dg.

For example, the final list Lf contains an ordered enumeration of the third-party users geographically closest to the called user. The final list Lf eliminates, for example, the initial list of third-party users who are geographically too far from the called user, beyond a predefined threshold distance.

In one variant, the order of steps E3 and E4 is reversed. Thus, it is possible to first select the third-party users who are geographically closest to the called user (E4) and then to verify which of those third-party users agree to be placed in contact with the called user based on the call's level of urgency.

In step E5, the selection module SEL transmits the final list Lf to the call processing module MTA which establishes a call between the calling user's communicating device DCa and a communicating device DCt of the third-party user who appears first in the final list.

The call processing module MTA thereby attempts to establish a call between the calling user's communicating device DCa and each of the communicating devices DCt of the third-party user which that third-party user has declared.

If the third-party user cannot be reached, the call processing module MTA establishes a call between the calling user's communicating device DCa and a communicating device DCt of each of the third-party users who appear in order in the final list.

The invention described here pertains to a method and server for contacting a called user who cannot be reached via his or her mobile phone. According to one embodiment of the invention, the steps of the inventive method are determined by the instructions of a computer program incorporated into a server, such as the communication server SC. The program comprises program instructions that, when said program is loaded and executed within the server, carry out the steps of the inventive method.

Consequently, the invention also applies to a computer program, particularly a computer program on or within an information medium, suitable to implement the invention. This program may use any programming language, and be in the form of source code, object code, or intermediate code between source code and object code, such as in a partially compiled form, or in any other form desirable for implementing the inventive method.

1. A method for contacting a user who owns a mobile terminal, who is the recipient of a call from a calling user's communicating device to the mobile terminal and who cannot be reached by means of the mobile terminal over a telecommunications network, said method comprising the following in a communication server:
determining an urgency level of the call,
determining a list of third-party users who may be placed in contact with the calling user, based on the social relationship between the called user and each third-party user, geolocation data related to the called user and related to third-party users, and the call's level of urgency, and
establishing a call between the calling user and at least one third-party user on the list.

2. A method according to claim 1, whereby the list contains an ordered enumeration of third-party users geographically closest to the called user.

3. A method according to claim 1, whereby the geolocation data comprises the last known geographic position of the called user end of each of the third-party users.

4. A method according to claim 1, whereby the geolocation data related to the called user comprises presence data related to the called user's calendar.

5. A method according to claim 1, whereby the communication server has previously saved a group of third-party users who have agreed to be potentially called in order to contact the called user, depending on the social relationship between the third-party user and the called user.

6. A method according to claim 5, whereby the communication server determines said list of third-party users by first producing an initial list from users belonging to said group based on the call's level of urgency, and by then producing said list based on geolocation data related to the called user and related to third-party users belonging to said initial list.

7. A method according to claim 1, whereby the call's level of urgency is determined by transferring the call to a voice server that has a system for evaluating the call's level of urgency.

8. A communication server for contacting a user who owns a mobile terminal, who is the recipient of a call from a calling user's communicating device to the mobile terminal and who cannot be reached by means of the mobile terminal over a telecommunications network, said communication server comprising:
means for determining a level of urgency of the call,
means for determining a list of third-party users who may be placed in contact with the calling user, based on the social relationship between the called user and each third-party user, geolocation data related to the called user and related to third-party users, and the call's level of urgency, and
means for establishing a call between the call to user and at least one third-party user on the list.

9. A computer program capable of being implemented in a server for contacting a user who owns a mobile terminal, who is the recipient of a call from a calling user's communicating device to the mobile terminal and who cannot be reached by means of the mobile terminal over a telecommunications network, sent program comprising instructions which, when the program is loaded and executed within said server, carry out the following:
determining an urgency level of the call,
determining a list of third-party users who may be placed in contact with the calling user, based on the social relationship between the called user and each third-party user, geolocation data related to the called user and related to third-party users, and the call's level of urgency, and
establishing a call between the calling user and at least one third-party user on the list.
